(19) United States
(12) Patent Application Publication
(10) Pub. No.: US 2025/0306210 A1
(43) Pub. Date: Oct. 2, 2025

(54) SENSOR MODULE WITH KINEMATIC MECHANISM, ROOF MODULE AND MOTOR VEHICLE

(71) Applicant: Webasto SE, Stockdorf (DE)

(72) Inventors: Magnus SVIBERG, Stockdorf (DE); Cédric LANGLAIS, Stockdorf (DE); Nikolaus LINNER, Stockdorf (DE); Thomas PODOLSKI, Stockdorf (DE)

(21) Appl. No.: 19/086,889

(22) Filed: Mar. 21, 2025

(30) Foreign Application Priority Data
Mar. 26, 2024 (DE) 10 2024 108 615.7

(51) Int. Cl. G01S 17/931; B60R 11/00; B60R 11/04

(52) U.S. Cl. CPC G01S 17/931; B60R 11/04; B60R 2011/0028; B60R 2011/0043

(57) ABSTRACT

A sensor module having an environment sensor and kinematic mechanism for adjusting the environment sensor, which fixes the environment sensor in an extended position in such a way that the latter is immovable with respect to an external force. The kinematic mechanism may have a first guide lever connected to the environment sensor; a second guide lever connected to the environment sensor; a tilting lever, which is connected to the sensor mount and the first guide lever; an adjustment lever, which is connected to the tilting lever and the second guide lever; a drive tilting lever, which is connected to the sensor mount, a first drive adjustment lever, which is connected to the second guide lever and the drive tilting lever; and a second drive adjustment lever, which is connected to the drive tilting lever and to the drive. The second guide lever is connected to the sensor mount.

### CROSS-REFERENCE TO RELATED APPLICATION(S)

This application claims the benefit of German Application No. DE 10 2024 108 615.7 filed Mar. 26, 2024, which is incorporated herein by reference in its entirety.

### TECHNICAL FIELD

The invention relates to a sensor module and also to a roof module for forming a vehicle roof on a motor vehicle having such a sensor module. The invention further relates to a motor vehicle having such a sensor module and/or such a roof module.

### BACKGROUND

Roof modules and sensor modules are used extensively in vehicle construction. Roof modules are prefabricated as separate functional modules, for example, and can be delivered to the assembly line when the vehicle is assembled. The roof module forms a roof skin of the vehicle roof on its outer surface, at least in some areas, which prevents moisture or air flow from penetrating into the vehicle roof. The roof skin is formed by one or more flat components, which can be made of a stable material, such as painted sheet metal or painted or colored plastic. The roof module can part of a rigid vehicle roof or part of an openable roof assembly.

Furthermore, developments in vehicle construction are increasingly focusing on autonomous or semi-autonomous vehicles. In order to enable the vehicle control system to control the vehicle autonomously or semi-autonomously, a large number of environment sensors (e.g., lidar sensors, radar sensors, (multi-) cameras, etc. together with other (electrical) components) are used and are often installed in the form sensor modules in the vehicle, and for example are arranged on or integrated into a roof module, detect the environment around the vehicle and determine, for example, a respective traffic situation from the detected environmental data. Roof modules that have at least one such sensor module are also known as Roof Sensor Modules (RSM). The known environment sensors, to this end, send or receive electromagnetic signals, for example laser beams or radar beams, wherein a data model of the vehicle environment can be generated by signal evaluation and used for vehicle control.

The sensor modules are usually attached to the vehicle roof, as the vehicle roof is usually the highest elevation of a vehicle from which the vehicle's surroundings are clearly visible. The sensor modules are designed, for example, as an attachment to the relevant vehicle roof. Furthermore, various adjustment mechanisms are known, by means of which a sensor module or an environment sensor contained therein can be adjusted at least between a retracted position and an extended position in which the vehicle environment is clearly visible.

Even though various adjustment mechanisms are already known, there are still challenges, particularly with regard to securely fixing the environment sensor in the retracted and/or extended position.

### SUMMARY

One object of the invention is to provide an improved sensor module. The object is achieved by a sensor module according to claim 1. The roof module according to claim 11 and the motor vehicle according to claim 12 are also subjects of the invention.

Advantageous aspects of the invention are the subject of the dependent claims. The scope of the invention includes all combinations of at least two components of the features disclosed in the description, the claims and/or the figures. It is understood that the explanations made with respect to the sensor module refer equivalently to the roof module and/or the motor vehicle, without being mentioned again redundantly for these. In particular, it is understood that the usual linguistic transformations and/or a corresponding replacement of respective terms in the context of customary linguistic practice, in particular the use of synonyms supported by generally recognized linguistic literature, are covered by the present disclosure without being explicitly mentioned in their respective formulation.

In a first aspect, it is proposed to use a sensor module comprising a sensor mount, at least one environment sensor, by means of which a vehicle environment can be detected and which is movable relative to the sensor mount, kinematic mechanism with a drive, which are designed to move the at least one environment sensor from a retracted position into an extended position and to fix the at least one environment sensor at least in the extended position in such a way that the at least one environment sensor is immovable with respect to an external force, wherein the kinematic mechanism further comprises a first guide lever connected to the environment sensor, in particular via a bearing point; a second guide lever connected to the environment sensor, in particular via a bearing point; a tilting lever, which is rotatably connected to the sensor mount in particular by a fixed bearing point and which is rotatably connected to the first guide lever in particular by a bearing point; an adjustment lever, which is rotatably connected to the tilting lever in particular by a bearing point and which is rotatably connected to the second guide lever in particular by a bearing point; a drive tilting lever, which is rotatably connected to the sensor mount in particular by a fixed bearing point, a first drive adjustment lever, which is rotatably connected to the second guide lever in particular by a bearing point and which is rotatably connected to the drive tilting lever in particular by a bearing point, and a second drive adjustment lever, which is rotatably connected to the drive tilting lever in particular by a bearing point and which is connected to the drive in particular by a bearing point, wherein the second guide lever is rotatably connected to the sensor mount in particular by a fixed bearing point.

The sensor module integrates a new type of controlled seven-joint kinematic mechanism with fixed bearing points or pivot points and individual levers of the kinematics in relation to the sensor mount. Furthermore, fixing the sensor in both positions can be improved by moving at least one of the levers into a top dead center position. In the retracted position, there are even several top dead center positions.

Compared to known kinematic mechanisms, the present sensor module enables improved control of the movement of the environment sensor with improved movement harmony. Furthermore, the kinematic mechanism has improved robustness and stability. The retraction and extension of the environment sensor can also be considered to be improved, especially due to optimized water management. Furthermore, the complex lever arrangement creates an integrated mounting or locking of the environment sensor in the end positions. Furthermore, the kinematic mechanism only has pivot points to enable the movement guidance of the environment sensor, which results in a more stable retraction and extension and a lower-maintenance kinematic mechanism. The kinematic mechanism also has several fixed bearing points, so that a stable retraction and extension of the environment sensor in relation to the sensor module or the sensor mount is possible. The sensor module impresses with its improved design and styling and also leads to an optimized layout and installation space. Furthermore, the kinematic mechanism reduces the weight and the manufacturing and maintenance costs. The main movement of the environment sensor is carried out via the proposed seven-joint kinematics. Furthermore, no sliding guide (via slideways) is required to adjust the sensor. The seven-joint kinematics couples the environment sensor either directly or indirectly to the sensor mount via several levers. The movement of the levers is controlled by a single drive. The movement of the drive, for example linear or rotary, can be converted into a complex movement of the kinematic mechanism or lever arrangement via the multiple fixed bearings.

The sensor mount can be a support frame. The sensor mount can be part of a vehicle body or a roof module body or a roof body.

In a further aspect, it is proposed that the second guide lever is L-shaped.

This allows complex motion control of the environment sensor to be implemented.

In a further aspect, it is proposed that the second guide lever is rotatably connected to the sensor mount by a fixed bearing point, the fixed bearing point being located in the area of a bend in the L-shaped second guide lever.

This fixed mounting allows a rear part of the environment sensor in particular to be adjusted relative to the sensor module. The front part of the sensor (viewed in the direction of an optical axis) is lifted using the first guide lever. The rear part of the sensor (viewed in the direction of an optical axis) is lifted via the second guide lever. The two guide levers are connected to each other via the adjustment lever so that the front and rear parts, and therefore the entire environment sensor, can be retracted and extended together.

In a further aspect, it is proposed that, in the retracted position of the environment sensor, the first guide lever and/or the tilting lever are in a top dead center position in order to fix the environment sensor in such a way that the at least one environment sensor is immovable with respect to an external force.

A top dead center position for levers describes a specific position in the mechanism of levers, at which a point is reached above the so-called dead center. The “dead center” is a term used in mechanics to describe a position in which the application of force has no direct influence on the movement of a system. In the case of a lever, this point is where the lever is least efficient in its movement, or where a change in the direction of movement is not possible. The top dead center position is therefore a position in which the lever in question has been moved beyond this inefficient point. This position serves as a safety mechanism to ensure that the movement takes place beyond a critical point and thus a stable position is achieved that can be maintained without additional force being applied. The top dead center position is achieved by moving the relevant lever(s) to a position in which the mechanical lock is secure after overcoming the dead center.

In a further aspect, it is proposed that, in the retracted position of the environment sensor, at least the drive tilting lever and preferably the first drive adjustment lever and/or the second drive adjustment lever are in a top dead center position, in order to fix the environment sensor via the adjustment lever in such a way that the at least one environment sensor is immovable with respect to an external force.

At least one of the drive levers is therefore in a further top dead center position. This provides double safety against unwanted movement of the environment sensor. At least one of the drive levers is in the top dead center position. However, several of the drive levers can also be in the top dead center position.

In a further aspect, it is proposed that, in the extended position of the environment sensor, at least the drive tilting lever and preferably the first drive adjustment lever and/or the second drive adjustment lever are in a top dead center position in order to fix the environment sensor via the adjustment lever in such a way that the at least one environment sensor is immovable with respect to an external force.

Even in the extended position, safety against undesirable retraction of the environment sensor can be achieved by at least one of the drive levers (again) being in a top dead center position. At least the drive tilting lever is in the top dead center position, as it is designed in such a way that it can assume two top dead center positions.

In a further aspect, it is proposed that the drive comprises a rotary drive or a linear guide drive, by means of which the at least one environment sensor can be moved from the retracted to the extended position.

A rotary drive describes that the movement is generated by rotation (rotary movement) of a part, typically a motor or a shaft. A linear guide drive generates a straight-line (linear) motion by means of electric linear drives, pneumatic or hydraulic cylinders.

In a further aspect, it is proposed that the linear drive has a spindle drive with a drive spindle and a spindle nut guided movably on the drive spindle along a drive axis, wherein the second drive adjustment lever is rotatably connected to the spindle nut by a bearing point.

A spindle drive is a mechanism for converting rotary motion into linear motion. The principle of a screw is used here to generate a linear movement when the drive spindle rotates. The drive spindle is the central element of the spindle drive, a long rod with a thread that rotates. The rotary movement of the spindle is used to generate the linear movement. Its movement along the drive axis enables the rotary movement to be converted into a linear movement. The spindle nut is matched to the thread of the drive spindle and can move along the spindle when it rotates. The movement of the spindle nut is linear along the axis, which is defined by the drive spindle. The adjustment lever is connected to the spindle nut via a bearing point. This connection enables the adjustment lever to rotate or adjust when the spindle nut moves along the spindle.

In a further aspect, it is proposed that the spindle nut in the retracted position of the environment sensor is in a stop position.

The stop position provides a further safety criterion to prevent undesired further movement of the nut on the spindle axis.

In a further aspect, it is proposed that the at least one environment sensor is a lidar sensor and/or a radar sensor and/or a camera sensor and/or a multi-camera sensor and/or an ultrasonic sensor and/or an infrared sensor.

In a further aspect, a roof module for forming a vehicle roof on a motor vehicle is proposed, comprising a surface component which forms a roof skin of the vehicle roof, at least in some areas, and which acts as an outer sealing surface of the roof module, and at least one sensor module as described above. The roof module can preferably be prefabricated and attached to the motor vehicle as a pre-assembly unit.

In a further aspect, it is proposed to provide a motor vehicle comprising at least one previously described roof module and/or at least one previously described sensor module. In principle, the sensor module can be located anywhere on the motor vehicle and designed for different purposes.

It is understood that the embodiments and examples mentioned above and to be explained below can be provided not only individually, but also in any combination without departing from the scope of the present invention. It is also understood that the embodiments and examples mentioned above and to be explained below relate in an equivalent or at least similar manner to all variants of the invention, without being mentioned separately in each case.

### BRIEF DESCRIPTION OF DRAWINGS

Embodiments of the invention are shown schematically in the drawings and are explained below by way of example. In the drawings:

FIG. 1 is a schematic representation of a roof module with a sensor module;

FIG. 2 shows a sensor module in a retracted position;

FIG. 3 shows the sensor module in an intermediate position;

FIG. 4 shows the sensor module in an intermediate position;

FIG. 5 shows the sensor module in an intermediate position;

FIG. 6 shows the sensor module in an intermediate position;

FIG. 7 shows the sensor module in an intermediate position;

FIG. 8 shows the sensor module in an intermediate position;

FIG. 9 shows the sensor module in an extended position;

FIG. 10 shows a lever arrangement of kinematic mechanism in a retracted position;

FIG. 11 shows the lever arrangement of the kinematic mechanism in an intermediate position;

FIG. 12 shows the lever arrangement of the kinematic mechanism in an intermediate position;

FIG. 13 shows the lever arrangement of the kinematic mechanism in an intermediate position;

FIG. 14 shows the lever arrangement of the kinematic mechanism in an intermediate position;

FIG. 15 shows the lever arrangement of the kinematic mechanism in an extended position; and

FIG. 16 shows a schematic representation of a seven-joint kinematic mechanism.

### DETAILED DESCRIPTION

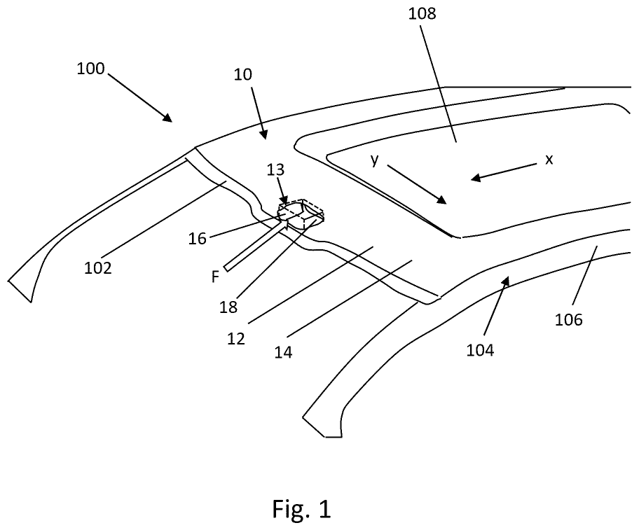

FIG. 1 shows a vehicle roof 100 of a vehicle comprising a roof module 10. The roof module 10 comprises a surface component 12 for forming the roof skin 14 of the vehicle roof 100 of the vehicle (not shown in its entirety). A sensor module 13 with an environment sensor 16 (in this case a lidar sensor) is arranged in a front-side, central roof area of the vehicle roof 100 or roof module 10 as viewed in a longitudinal direction x of the vehicle. The sensor module 13 also comprises a sensor mount 15. Other sensor types, e.g. a radar sensor, and/or a camera sensor and/or a multi-camera sensor can also be used. The vehicle longitudinal direction x is aligned transversely, in particular orthogonally to a vehicle width direction y.

The environment sensor 16 is arranged behind a front cross member 102, which defines a roof-side wind path of the vehicle.

The sensor module 13 also comprises a kinematic mechanism 18. The kinematic mechanism 18 makes it possible to adjust the environment sensor 16 from a retracted position A to an extended position H, in which the environment sensor 16 protrudes at least partially above the roof skin 14, and also to fix the environment sensor 16 in the retracted position A and in the extended position H in such a way that the environment sensor 16 is immovable with respect to an external force F.

The force F can, for example, be an air resistance force that acts on the environment sensor 16 in the extended position. Alternatively or additionally, it can also be, for example, a wind force or another external force.

The roof module 10 is preferably inserted as a pre-assembly unit into a roof frame 104 of the vehicle or is placed on the at least two cross members 102 and at least two longitudinal members 106, by which the roof frame 104 is formed. The roof module 10 in the exemplary embodiment shown comprises a panoramic roof 108.

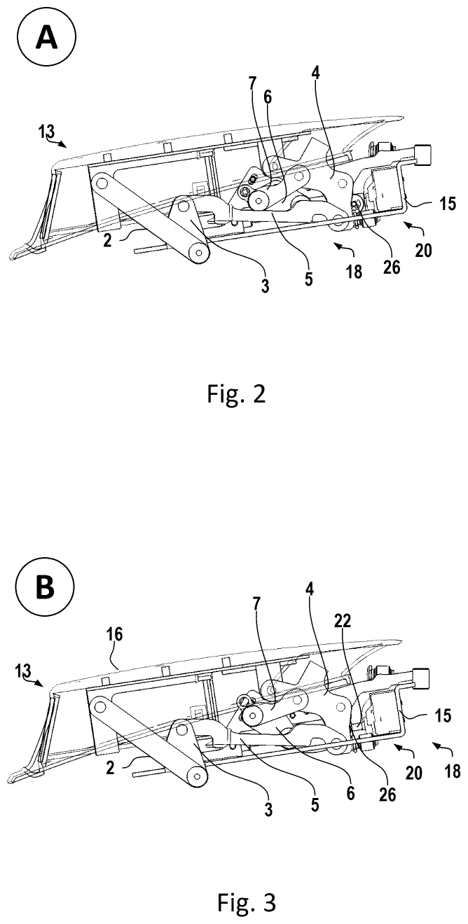

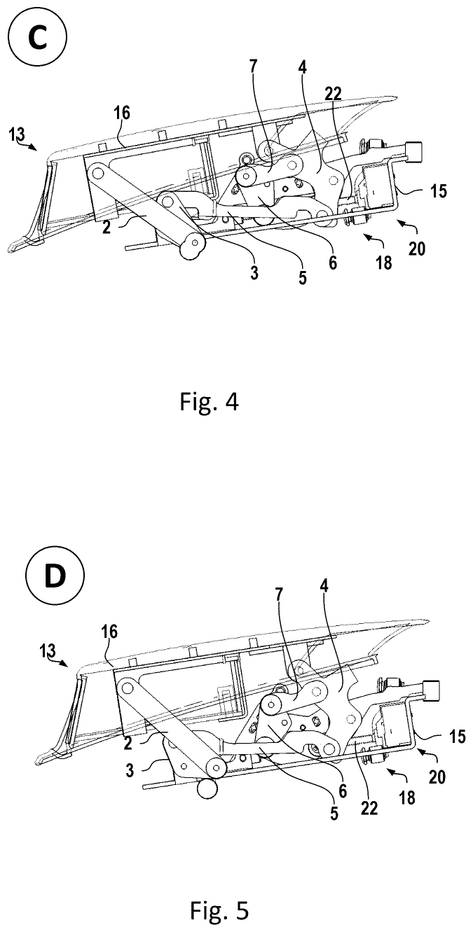

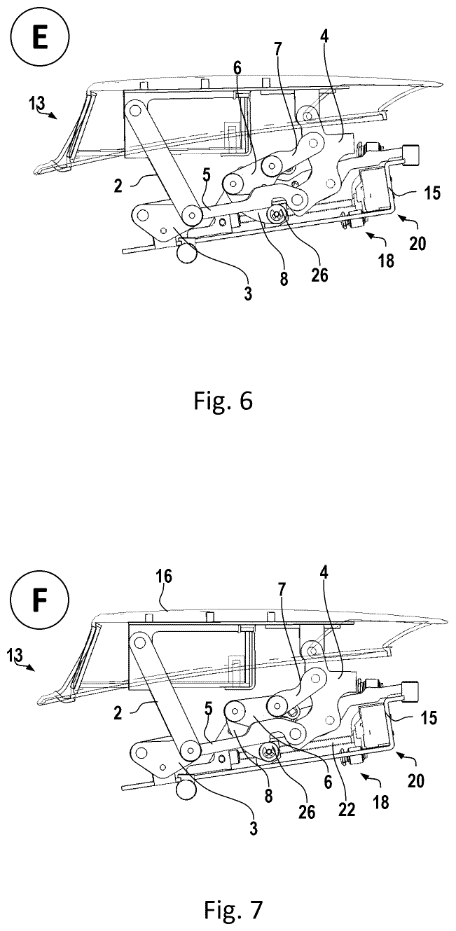

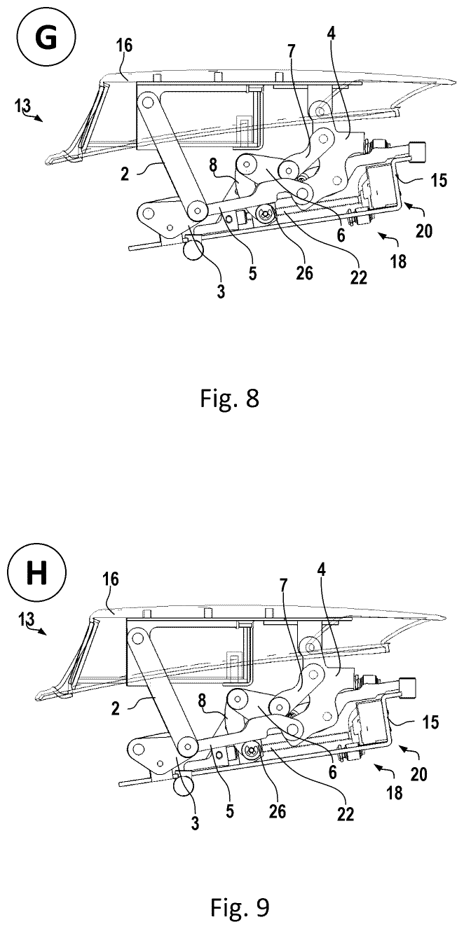

FIGS. 2 to 9 schematically show a movement sequence for adjusting the environment sensor 16 between the retracted position A and the extended position H. The environment sensor is also shown in several intermediate positions B-G.

Position A shows the environment sensor 16 in a completely closed position and locked by the kinematic mechanism. Position B shows the environment sensor 16 after the lock has been released by a drive 20, thus opening a top dead center position in which the kinematic mechanism was located. Position C shows the environment sensor 16 or a rear edge of the environment sensor 16 being lifted by the, in the present case, seven-joint kinematic mechanism 18 via the drive 20. Position D shows a further lifting and turning of the environment sensor 16 by the seven-joint kinematic mechanism 18. Position E shows a further lifting and turning of the environment sensor 16 up to a stop, not shown in detail. Position F shows an adjustment of the locking mechanism by the drive 20 by moving at least one lever of the kinematic mechanism into a top dead center position. Position H shows the environment sensor 16 in the extended, fully open position, in which the environment sensor 16 is locked by the top dead center position mechanism.

The drive 20 can be a rotary drive or a linear guide drive, by which the at least one environment sensor 16 can be moved from the retracted position A to the extended position H. A linear guide drive is shown here. The linear drive has a spindle drive with a drive spindle 22 and a spindle nut 26 guided on the drive spindle 22 so as to be movable along a drive axis 24. The spindle nut 24 is in a stop position in the retracted position of the environment sensor 16.

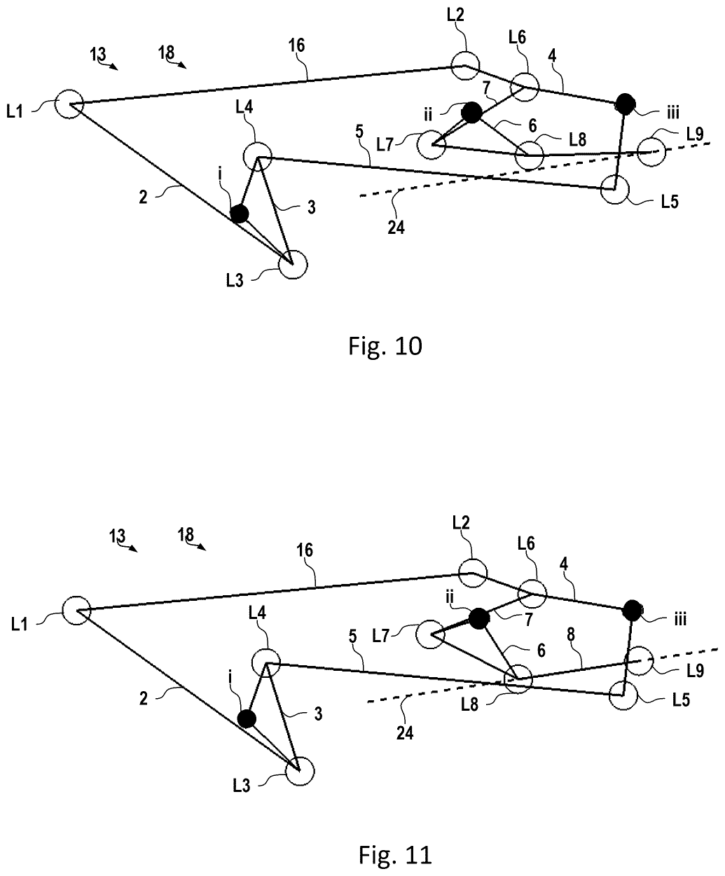

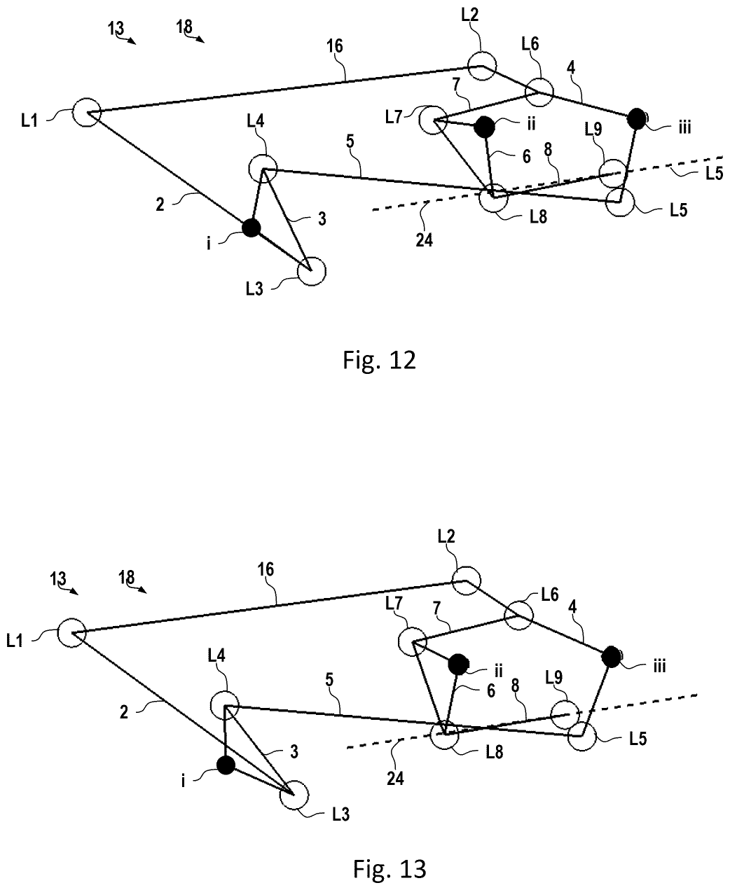

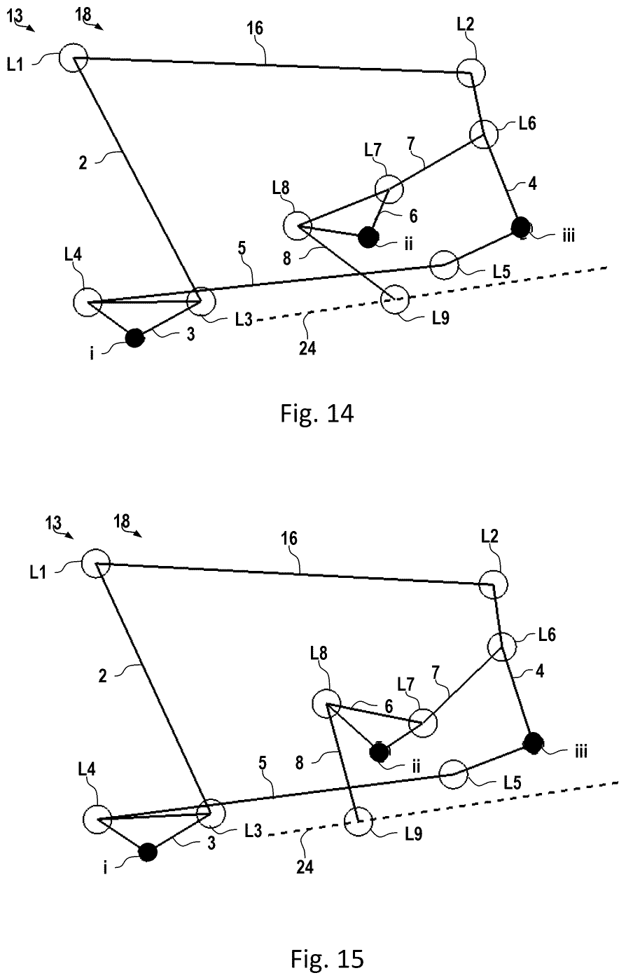

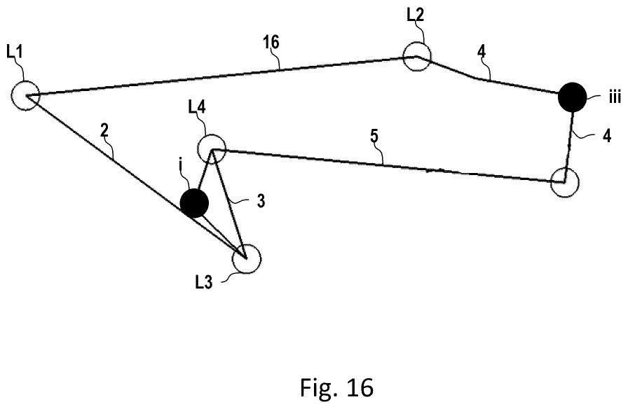

The other components shown in FIGS. 2 to 9 are described with reference to FIGS. 10 to 15, wherein the same reference signs are used for the same components.

In FIGS. 10 to 15, the levers of the kinematic mechanism 18 of the sensor module 13 are shown in a schematically simplified manner in order to also display the relevant pivot points.

With reference to FIGS. 10 to 15, the kinematic mechanism is characterized in greater detail.

The kinematic mechanism 18 has a first guide lever 2 connected to the environment sensor 16, in particular via a bearing point L1, a second guide lever 3 connected to the environment sensor 16 and a second guide lever 3 connected to the environment sensor 16, in particular via a bearing point L2. The second guide lever 4 is L-shaped. The second guide lever 4 is rotatably connected to the sensor mount 15 by a fixed bearing point iii, wherein the fixed bearing point iii is located in the area of a bend in the L-shaped second guide lever 4.

The kinematic mechanism 18 has a tilting lever 3, which is rotatably connected to the sensor mount 15, in particular by a fixed bearing point i, and which is rotatably connected to the first guide lever 2, in particular by a bearing point L3; and an adjustment lever 5, which is rotatably connected to the tilting lever 3, in particular by a bearing point L4, and which is rotatably connected to the second guide lever 4, in particular by a bearing point L5.

To drive the adjustment movement, the kinematic mechanism 18 has a drive tilting lever 6, which is rotatably connected to the sensor mount 15 in particular by a fixed bearing point ii, a first drive adjustment lever 7, which is rotatably connected to the second guide lever 4, in particular by a bearing point L6, in particular by a bearing point L7; and a second drive adjustment lever 8, which is rotatably connected to the drive tilting lever 6, in particular by a bearing point L8, and which is connected to the drive 20, in particular by a bearing point L9. The second drive adjustment lever 8 is rotatably connected to the spindle nut 24 by a bearing point L9.

The second guide lever 5 is rotatably connected to the sensor mount 15 in particular by a fixed bearing point iii.

In the retracted position A (see FIGS. 2 and 10) of the environment sensor 16, the first guide lever 2 and the tilting lever 3 are in a top dead center position in order to fix the environment sensor 16 in such a way that the at least one environment sensor 16 is immovable with respect to the external force F. Furthermore, in the retracted position A of the environment sensor 16, at least the drive tilting lever 6 and preferably the first drive adjustment lever 7 and/or the second drive adjustment lever 8 is or are in a top dead center position in order to fix the environment sensor 16 via the adjustment lever 5 in such a way that the at least one environment sensor 16 is immovable with respect to the external force F.

In the extended position H (see FIGS. 9 and 15) of the environment sensor 16, at least the drive tilting lever 6 and preferably the first drive adjustment lever 7 and/or the second drive adjustment lever 8 are in a further top dead center position in order to fix the environment sensor 16 via the adjustment lever 5 in such a way that the at least one environment sensor 16 is immovable with respect to the external force F.

### LIST OF REFERENCE SIGNS

2 guide lever
3 tilting lever
4 guide lever
6 drive tilting lever
7 drive adjustment lever
8 drive adjustment lever
10 roof module
12 surface component
13 sensor module
14 roof skin
15 sensor mount
16 environment sensor
18 kinematic mechanism
20 drive
x vehicle longitudinal direction
y vehicle width direction

1. A sensor module comprising:
a sensor mount,
at least one environment sensor configured to detect a vehicle environment and which is movable relative to the sensor mount,
a kinematic mechanism with a drive configured to move the at least one environment sensor from a retracted position into an extended position and to fix the at least one environment sensor at least in the extended position in such a way that the at least one environment sensor is immovable with respect to an external force,
wherein the kinematic mechanism also has:
a first guide lever connected to the environment sensor;
a second guide lever connected to the environment sensor;
a tilting lever, which is rotatably connected to the sensor mount and which is rotatably connected to the first guide lever;
an adjustment lever, which rotatably connected to the tilting lever and which is rotatably connected to the second guide lever;
a drive tilting lever, which is rotatably connected to the sensor mount,
a first drive adjustment lever, which is rotatably connected to the second guide lever and which is rotatably connected to the drive tilting lever; and
a second drive adjustment lever, which is rotatably connected to the drive tilting lever and which is connected to the drive;
wherein the second guide lever is rotatably connected to the sensor mount.

2. The sensor module as claimed in claim 1, wherein the second guide lever is L-shaped.

3. The sensor module as claimed in claim 2, wherein the second guide lever is rotatably connected to the sensor mount by a fixed bearing point, wherein the fixed bearing point is located in the area of a bend in the L-shaped second guide lever.

4. The sensor module as claimed in claim 1, wherein, in the retracted position of the environment sensor, the first guide lever and the tilting lever are located in a top dead center position in order to fix the environment sensor in such a way that the at least one environment sensor is immovable with respect to an external force.

5. The sensor module as claimed in claim 1, wherein, in the retracted position of the environment sensor, at least the drive tilting lever and the first drive adjustment lever and/or the second drive adjustment lever are in a top dead center position in order to fix the environment sensor via the adjustment lever in such a way that the at least one environment sensor is immovable with respect to an external force.

6. The sensor module as claimed in claim 1, wherein, in the extended position of the environment sensor, at least the drive tilting lever and the first drive adjustment lever and/or the second drive adjustment lever are in a top dead center position in order to fix the environment sensor via the adjustment lever in such a way that the at least one environment sensor is immovable with respect to an external force.

7. The sensor module as claimed in claim 1, wherein the drive has a rotary drive or a linear guide drive by means of which the at least one environment sensor can be moved from the retracted to the extended position.

8. The sensor module as claimed in claim 7, wherein the linear drive has a spindle drive with a drive spindle and a spindle nut guided movably on the drive spindle along a drive axis, wherein the second drive adjustment lever is rotatably connected by a bearing point to the spindle nut.

9. The sensor module as claimed in claim 8, wherein the spindle nut is in a stop position in the retracted position of the environment sensor.

10. The sensor module as claimed in claim 1, wherein the at least one environment sensor is at least one of a lidar sensor, a radar sensor, a camera sensor, and a multi-camera sensor.

11. A roof module for forming a vehicle roof on a motor vehicle, comprising a surface component which forms a roof skin of the vehicle roof, at least in some areas, and which acts as an outer sealing surface of the roof module, and a sensor module as claimed in claim 1.

12. A motor vehicle comprising a roof module as claimed in claim 11.

13. A motor vehicle comprising a roof module as claimed in claim 11 and a sensor module as claimed in one claim 1.

14. A motor vehicle comprising a roof module as claimed in claim 11 and a sensor module as claimed in one claim 10.

15. A motor vehicle comprising a sensor module as claimed in claim 1.

16. A motor vehicle comprising a sensor module as claimed in claim 10.
